(19) United States
(12) Patent Application Publication
(10) Pub. No.: US 2008/0204374 A1
(43) Pub. Date: Aug. 28, 2008

(54) Method and apparatus for driving an AMOLED with variable driving voltage

(75) Inventors: Sebastien Weitbruch, Kappel (DE); Carlos Correa, Villingen-Schwenningen (DE); Cedric Thebault, Villingen-Schwenningen (DE)

Correspondence Address: Joseph J. Laks;Thomson Licensing LLC, 2 Independence Way, Patent Operations, PO Box 5312, PRINCETON, NJ, 08543, US

(73) Assignee: THOMSON LICENSING

(21) Appl. No.: 11/824,100

(22) Filed: Jun. 28, 2007

(30) Foreign Application Priority Data
Jun. 30, 2006 (EP) 06300742.1

(51) Int. Cl. G09G 3/30

(52) U.S. Cl. 345/76

(57) ABSTRACT

The sharpness impression when displaying a movement on an AMOLED (Active Matrix Organic Light Emitting Display) shall be improved. For this purpose, an apparatus for driving a cell of an AMOLED is provided including driving means for applying a driving voltage to the cell and for applying a luminance control signal to the cell during a pregiven time frame. The apparatus further includes controlling means for varying the driving voltage within the time frame according to a predefined function of time. For example, the driving voltage may be varied in the form of a triangle so that the lighting time over the frame is reduced while a CRT like behavior is emulated.

### FIELD OF THE INVENTION

The present invention relates to a method for driving a cell of an AMOLED (Active Matrix Organic Light Emitting Display) including the steps of applying a driving voltage to the cell and applying a luminance control signal to the cell during a pregiven time frame. Furthermore, the present invention relates to an apparatus for driving such a cell.

### BACKGROUND OF THE INVENTION

The structure of an active matrix OLED or AMOLED is well known. According to FIG. 1 it comprises:

an active matrix 1 containing, for each cell, an association of several TFTs T1, T2 with a capacitor C connected to an OLED material. The capacitor C acts as a memory component that stores a value during a part of the video frame, this value being representative of a video information to be displayed by the cell 2 during the next video frame or the next part of the video frame. The TFTs act as switches enabling the selection of the cell 2, the storage of a data in the capacitor and the displaying by the cell 2 of a video information corresponding to the stored data;

a row or gate driver 3 that selects line by line the cells 2 of the matrix 1 in order to refresh their content;

a column or source driver 4 that delivers the data to be stored in each cell 2 of the current selected line; this component receives the video information for each cell 2; and

a digital processing unit 5 that applies required video and signal processing steps and that delivers the required control signals to the row and column drivers 3, 4.

Actually, there are two ways for driving the OLED cells 2. In a first way, each digital video information sent by the digital processing unit 5 is converted by the column drivers 4 into a current whose amplitude is directly proportional to the video level. This current is provided to the appropriate cell 2 of the matrix 1. In a second way, the digital video information sent by the digital processing unit 5 is converted by the column drivers 4 into a voltage whose amplitude is proportional to the square of the video level. This current or voltage is provided to the appropriate cell 2 of the matrix 1.

However, in principle, an OLED is current driven so that each voltage based driven system is based on a voltage to current converter to achieve appropriate cell lighting.

From the above, it can be deduced that the row driver 3 has a quite simple function since it only has to apply a selection line by line. It is more or less a shift register. The column driver 4 represents the real active part and can be considered as a high level digital to analog converter.

The displaying of a video information with such a structure of AMOLED is symbolized in FIG. 2. The input signal is forwarded to the digital processing unit that delivers, after internal processing, a timing signal for row selection to the row driver synchronized with the data sent to the column driver 4. The data transmitted to the column driver 4 are either parallel or serial. Additionally, the column driver 4 disposes of a reference signaling delivered by a separate reference signalling device 6. This component 6 delivers a set of reference voltages in case of voltage driven circuitry or a set of reference currents in case of current driven circuitry. The highest reference is used for the white and the lowest for the smallest gray level. Then, the column driver 4 applies to the matrix cells 2 the voltage or current amplitude corresponding to the data to be displayed by the cells 2.

Independently of the chosen AMOLED concept—current-driven or voltage-driven—the grayscale level is defined by storing during one frame an analog value in a capacitor located at the current pixel location. This value is kept by the pixel up to the next refresh coming with the next frame. In that case, the video value is rendered in a fully analog way and stays stable during the whole frame. This concept is different from that of a CRT which works with an impulse as depicted in FIG. 3.

As shown on the left hand side of the Figure, the selected pixel of a CRT will receive a pulse coming from the beam and generating on the phosphor a lighting peak that decreases rapidly depending on the phosphor persistence. A new peak will be produced exactly one frame later (e.g. 20 ms later for 50 hz, 16.67 ms later for 60 Hz and so on).

In case of an AMOLED (compare right hand side of FIG. 3, the luminance of the current pixel is stable during the whole frame period. The value of the pixel will be updated only at the beginning of each frame. In the previous example, the surface of the illumination curves for level 1 and level 2 are equal between CRT and AMOLED if the same power management system is used. All amplitudes being controlled in an analog way.

In the following the motion rendition with an AMOLED in view of human optokinetics shall be explained in detail. In a reflex mechanism called optokinetic nystagmus, the eyes pursue a moving scene to keep the image stationary on the retina.

A motion-picture film is a strip of discrete, still pictures but produces the visual impression of continuous movement. In part, such effects of apparent movement (called the visual phi phenomenon) depend on the persistence of vision: visual response outlasts a stimulus by a fraction of a second. FIG. 4 illustrates the eye movement in the case of displaying a gray disk moving on a black background.

From a frame N to a following frame N+1 the eye will perform a movement as shown in the Figure. Simultaneously, it will integrate objects lying on a time line. The brain tries to fill spaces between the visual objects of the frames.

FIG. 5 shows the difference between the picture rendition of a gray moving circle on a dark background for a CRT and an AMOLED. In the case of a CRT, the impulse rendition suits very well to the visual phi phenomenon. Indeed, the brain has no problem to identify the CRT information as a continuous movement.

However, in the case of the AMOLED picture rendition, the object seems to stay stationary during a whole frame before jumping to a new position in the next frame. Such a movement is quite difficult to be interpreted by the brain that results in either blurred pictures or vibrating pictures (judder).

In order to be able to understand the AMOLED picture rendition, it is necessary to know the AMOLED addressing method and the hardware used for the AMOLED cells. The principle structure of a cell is already known from FIG. 1. The TFT T2 can be realized with a n-channel or a p-channel. FIG. 6 shows a comparison between p and n type TFT for this AMOLED application. The main differences reside in the global driving voltages as described below:
N-channel: The OLED diode D has a threshold voltage named Vₜₕ. In that case, the value stored in the capacitor C must be higher than Vₜₕ to light the diode. Furthermore, the higher this value will be the more luminous the diode will light. In addition, it is possible to modify globally the lighting of all diodes by simply changing the GND level. If the GND is high (e.g. more than Vdd) then the diode D will not light anymore.
P-channel: In that case the value stored in the capacitor C must be lower than (Vdd−Vₜₕ) to light the diode D. Furthermore, the lower this value will be the more luminous the diode D will light. In addition, it is possible to modify globally the lighting of all diodes by simply changing the driving voltage potential Vdd. If Vdd is low (e.g. lower than Vₜₕ) then the diode D will not light anymore.

These two differences will be important for the invention.

In the addressing phase of the AMOLED, the row driver will open the transistor T1 by applying a high level (n-channel) or a low level (p-channel) signal via the “Line (k)”. Then the signal level given on the “Column” at this time will be stored in the capacitor C as illustrated in FIG. 7.

The example given in FIG. 7 is based on a QVGA display with 240 lines and 320 pixels (RGB→960 cells). The driving voltage between Vdd and GND is fixed during the whole time (values are given here only as example). The vertical synchronization pulse V is high at the starting of each frame. This signal launches the addressing of the display (row or line pulse) given for row 0 to row 239 where the corresponding data signals are given on the 960 columns line by line. Finally the video information can be seen as shown in FIG. 8. It shows that pictures are displayed one after the other based on the V synchronization signal with a delay from lines to lines due to the addressing operation (the time needed for changing the capacitor value is not negligible).

In other words, one given pixel from the first line (e.g. value 255 in frame T and 128 in frame T+1) will have the behavior illustrated in FIG. 9. This Figure shows the same example as presented in FIG. 4. As already explained this way of video rendition will introduce a lack of sharpness during the movement.

In the international patent application WO 05/104074 a specific method for sub-frame coding is introduced in order to improve motion rendition of AMOLEDs. Furthermore, The European patent application 05292759.7 describes an improvement of this method in the specific case of 50 Hz frame rate mode.

### SUMMARY OF THE INVENTION

In view of that it is the object of the present invention to provide a method and apparatus for driving a cell of an AMOLED so that the sharpness impression during the movement of an object on the AMOLED is improved.

This object is solved by a method for driving a cell of an AMOLED including the steps of applying a driving voltage to said cell and applying a luminance control signal to said cell during a pregiven time frame, as well as varying said driving voltage within said time frame according to a predefined triangle function of time.

Furthermore, there is provided an apparatus for driving a cell of an AMOLED including driving means for applying a driving voltage and a luminance control signal to said cell during a pregiven time frame, as well as controlling means for varying said driving voltage within said time frame according to a predefined triangle function of time.

The time frame defined above may correspond to the time of a signal frame for displaying a picture on the AMOLED. Moreover, the time frame may also correspond to a sub-frame of the luminance control signal, i.e. the video signal. Specifically, the above described method or apparatus can be combined with a sub-frame coding technique of the international patent application WO 05/104074. Furthermore, the invention can also be combined with the concept presented in the European patent application 05292759.7 introduced above.

Preferably, the driving voltage is reduced to a pregiven addressing time interval within the above-defined time frame. Thus, the emission of light is deactivated during the addressing operation.

The driving voltage may be increased or decreased continuously within the time frame. Such slope of the driving voltage simulates a CRT, so that the sharpness impression of the picture displayed on the AMOLED is enhanced.

Alternatively, the driving voltage may be increased and decreased continuously within in the time frame. This driving principle also ensures that the maximum light emission only appears in a part of the frame.

Furthermore, the driving voltage may be given by a driving potential and a ground potential, and the ground potential may be modified for varying the driving voltage. Of course, alternatively or additionally, the driving potential may be modified for varying the driving voltage. The appropriate modification of the driving voltage depends on the hardware of a cell used.

### BRIEF DESCRIPTION OF THE DRAWINGS

Exemplary embodiments of the invention are illustrated in the drawings and are explained in more detail in the following description.

The drawings showing in:

FIG. 1 a principle diagram of the electronics of an AMOLED;

FIG. 2 a principle diagram of AMOLED drivers;

FIG. 3 a comparison of the illumination surfaces for a frame of a CRT and an AMOLED;

FIG. 4 a principle diagram for explaining the optokinetic nystagmus or eye tracking;

FIG. 5 a comparison of CRT versus AMOLED for a moving circle;

FIG. 6 a comparison of p and n type TFT of an AMOLED cell;

FIG. 7 the AMOLED addressing concept;

FIG. 8 a view of video information subjected to AMOLED addressing;

FIG. 9 the amplitude of a given AMOLED pixel;

FIG. 10 the inventive concept of triangle driving (n-channel);

FIG. 11 four methods of triangle driving;

FIG. 12 the amplitude of a given AMOLED pixel with triangle driving (method 1);

FIG. 13 the amplitude of a given AMOLED pixel with triangle driving (method 3);

FIG. 14 a further concept of triangle driving (p-channel) and

FIG. 15 a block diagram for implementing a display device according to the present invention.

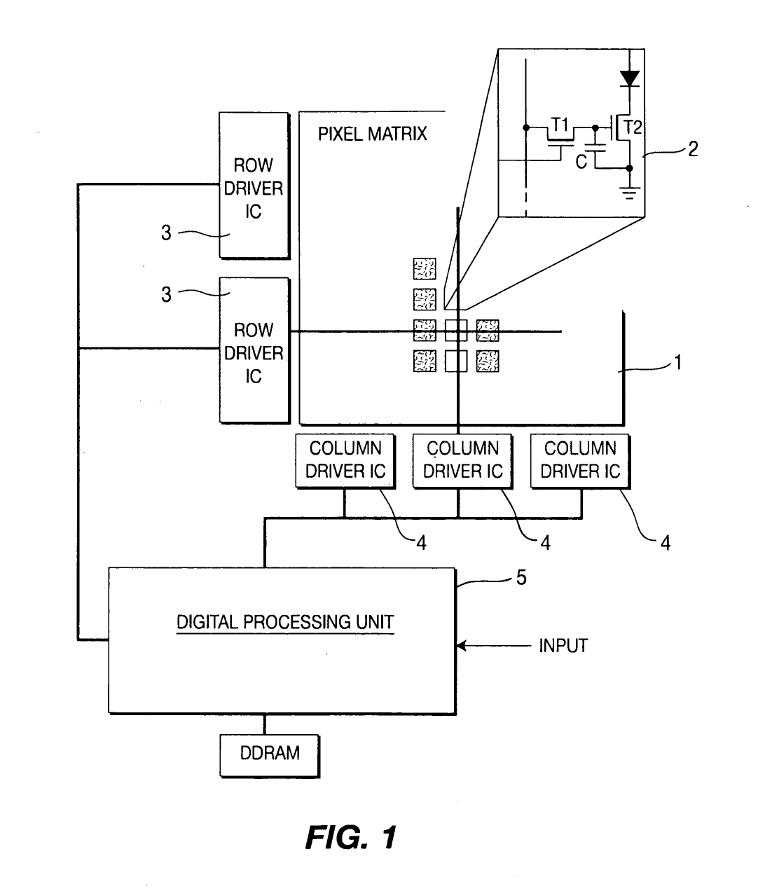

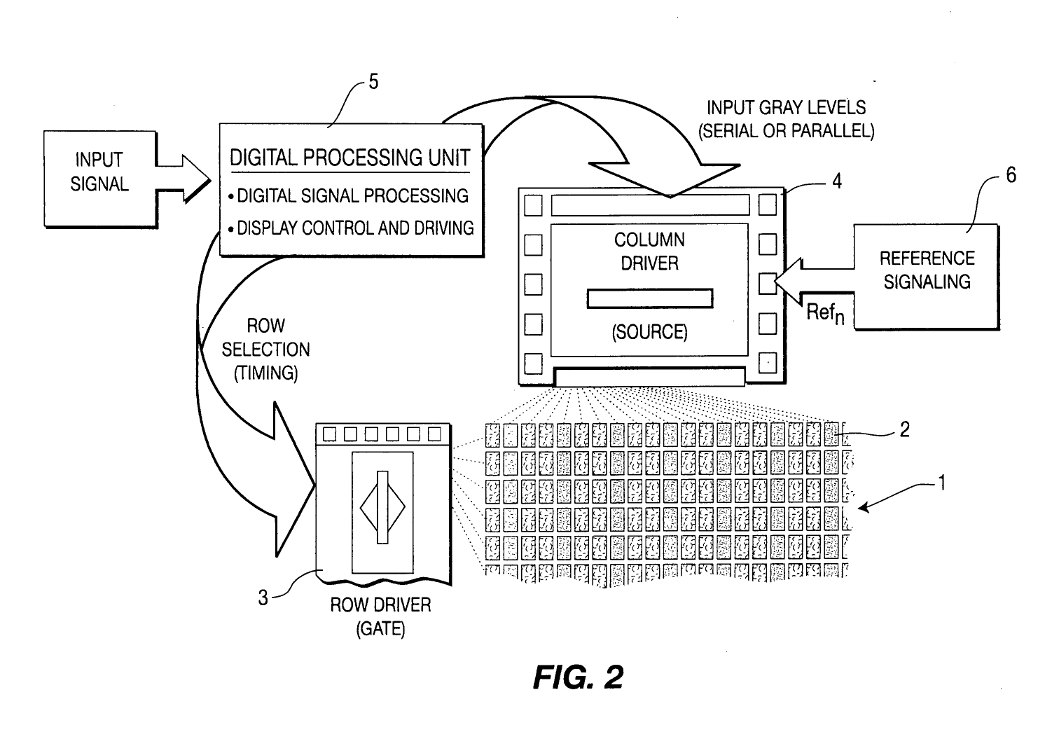

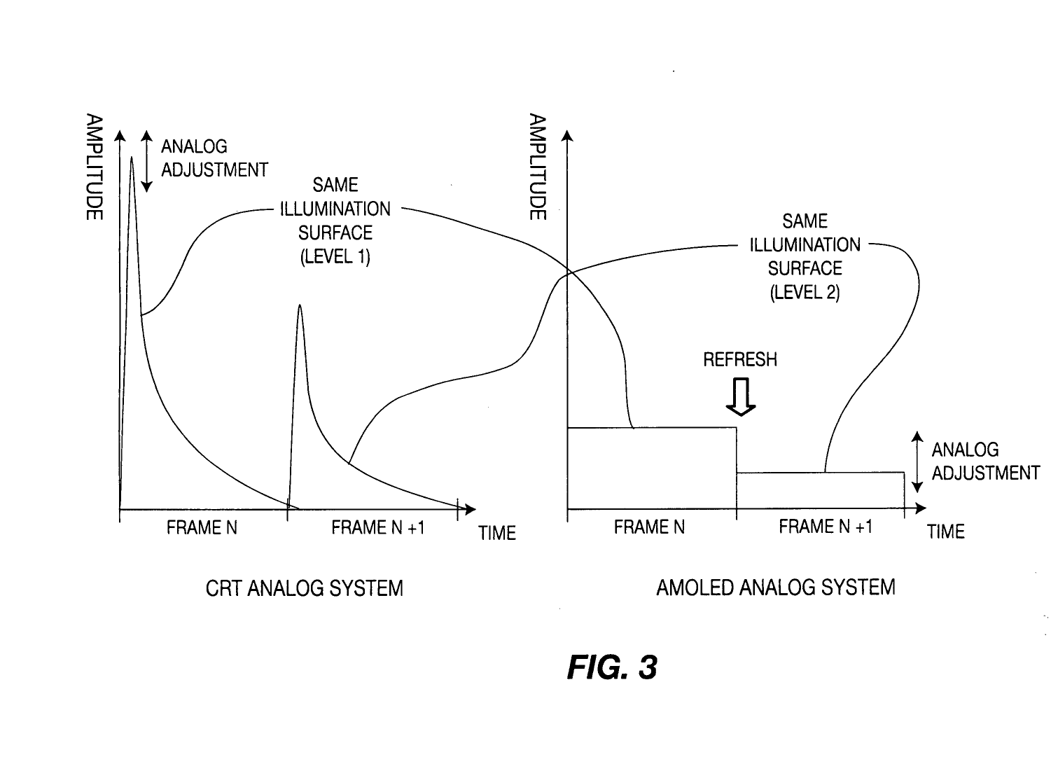

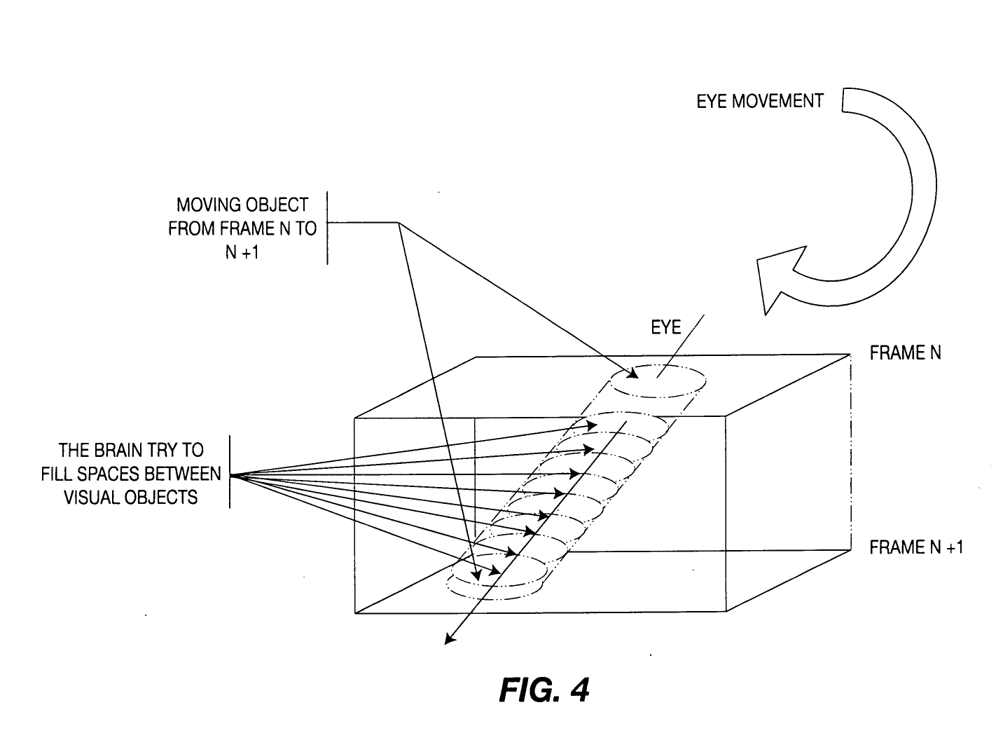

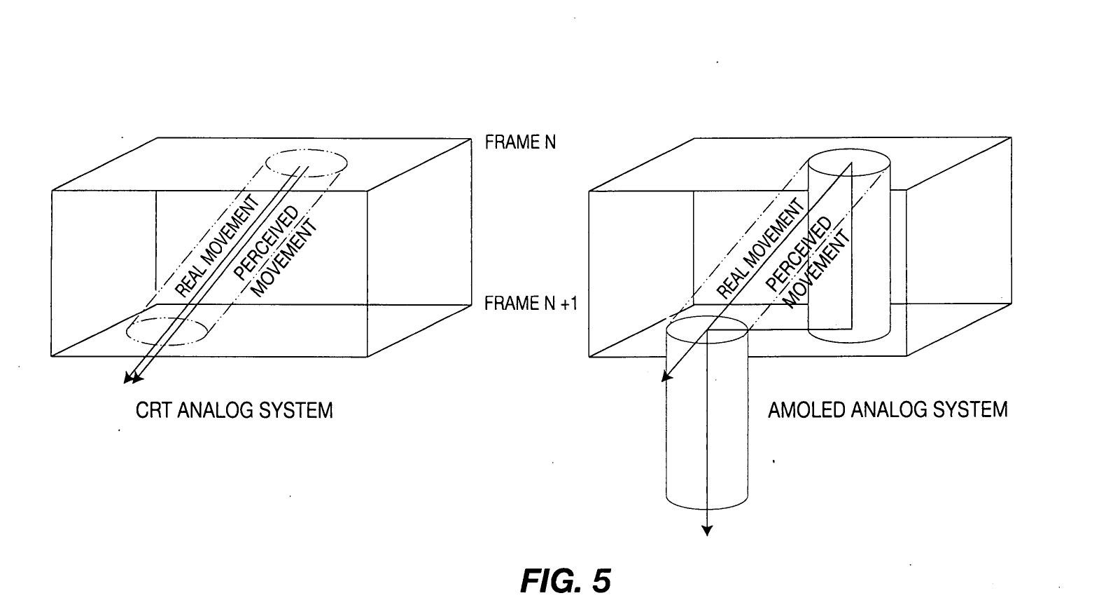

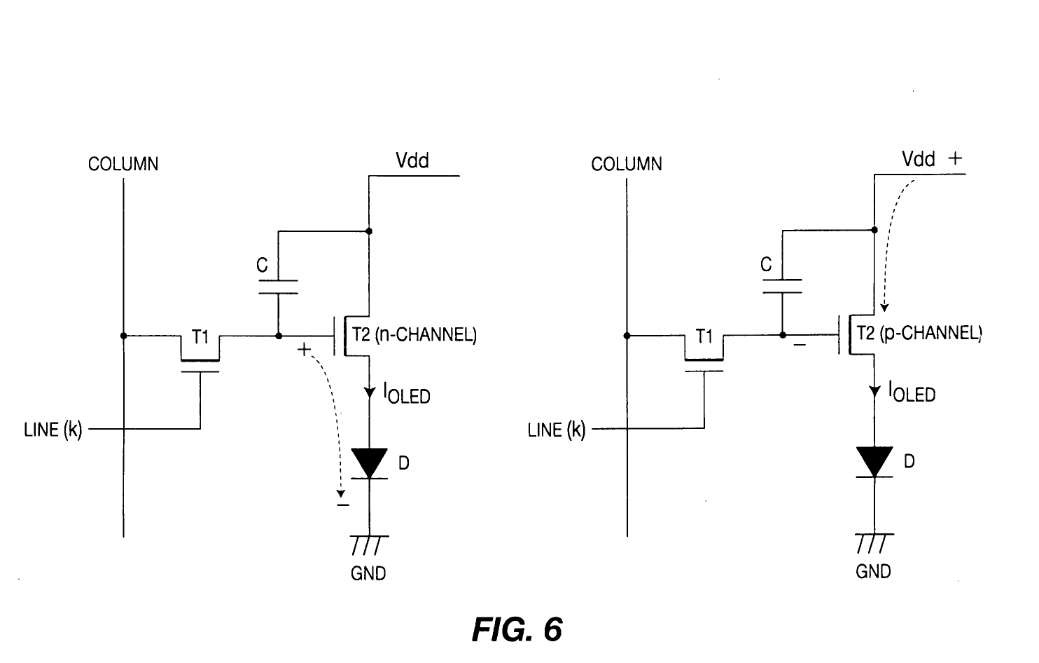

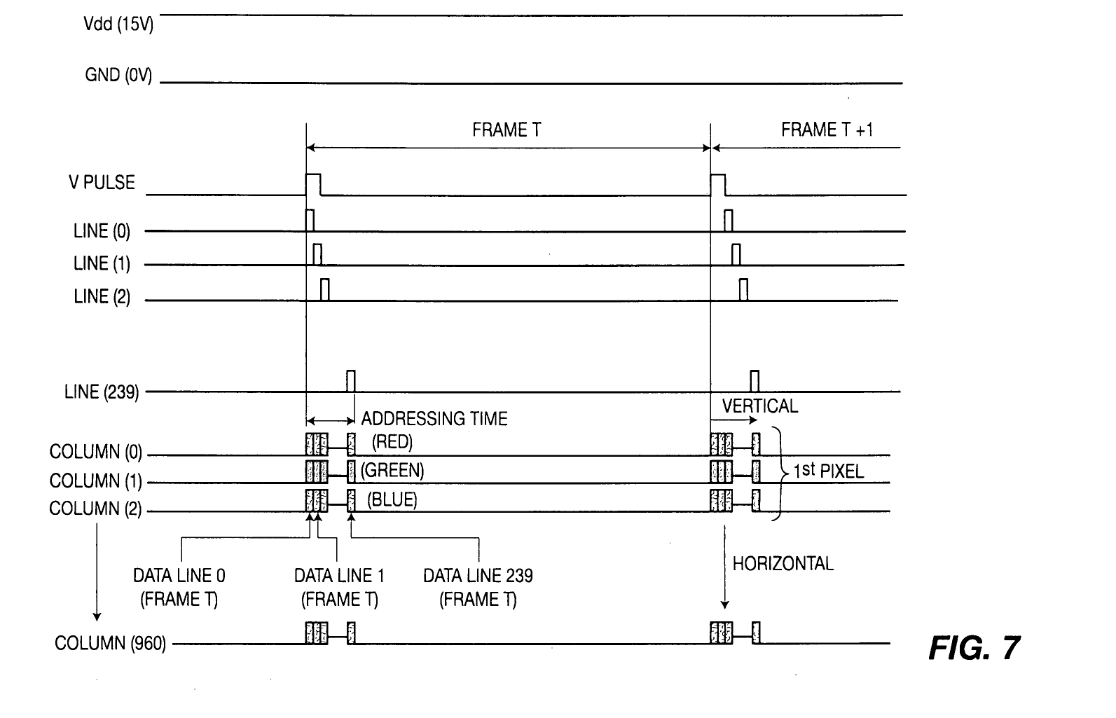

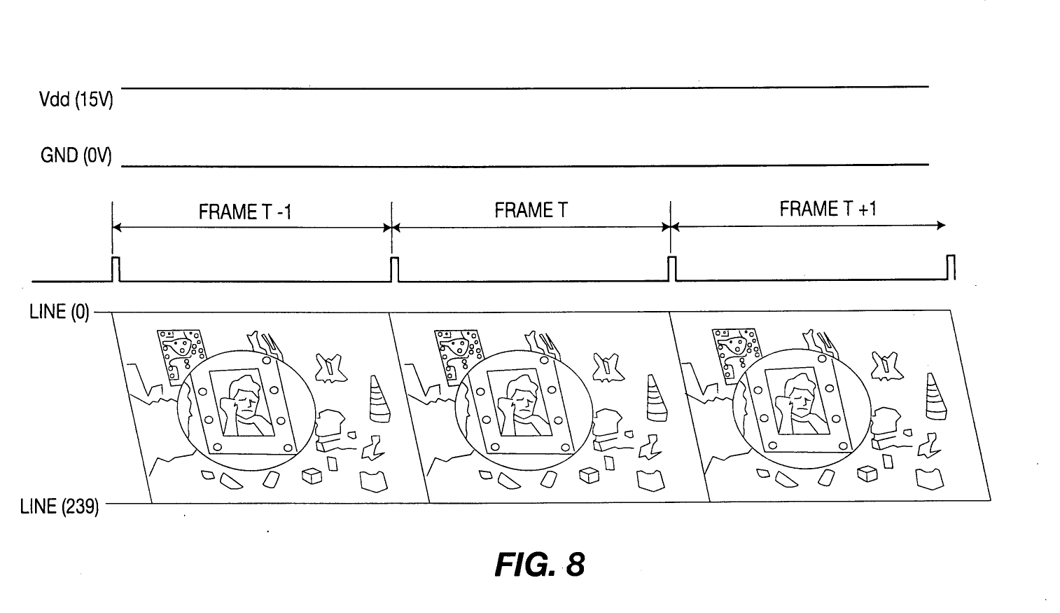

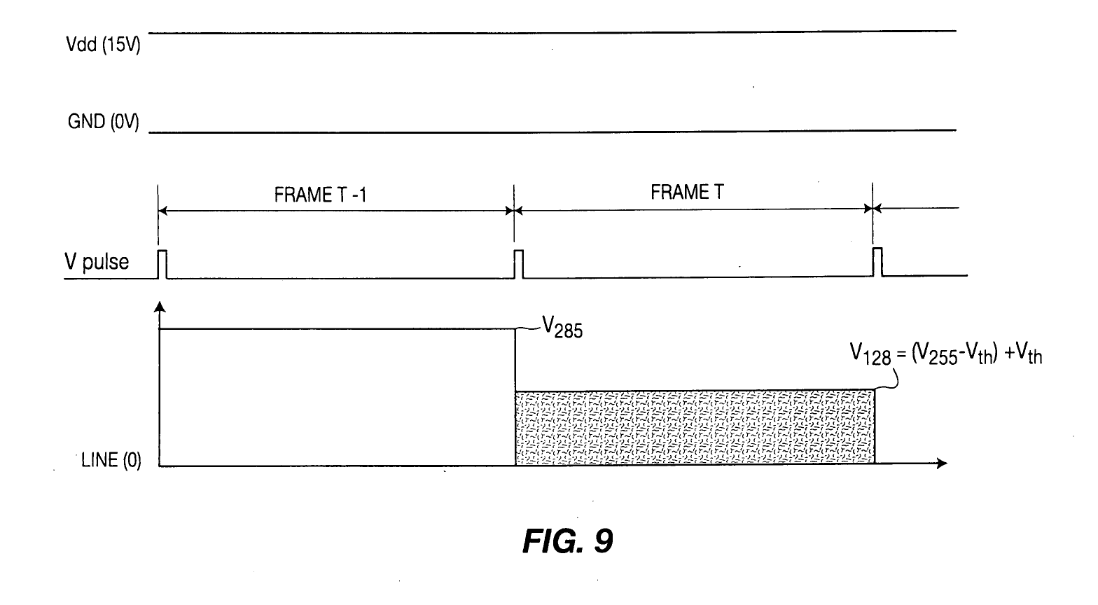

### DETAILED DESCRIPTION OF PREFERRED EMBODIMENTS

The present invention aims on presenting a new AMOLED gray scale rendition method overcoming the problem on motion rendition issues. The idea is to have a lighting emission which is more similar to that of a CRT. For that purpose the driving voltage will be modified as presented in the examples below.

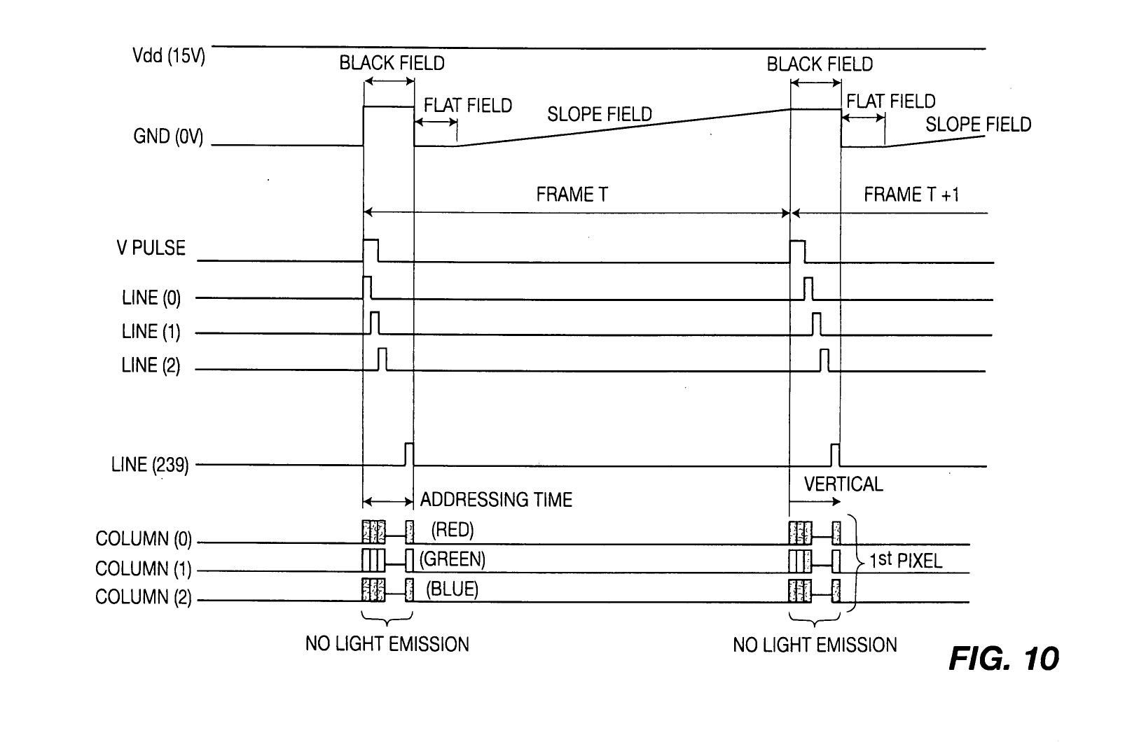

FIG. 10 illustrates a first concept for triangle driving in case of n-channel TFTs. The driving potential Vdd is kept constant and a driving voltage is given by the difference of the driving potential Vdd and the ground potential GND.
During the addressing operation, the emission of light is deactivated by setting the GND to high. This will avoid a difference of lighting between first and last lines.
Directly afterwards, the GND is kept to low during a given time called flat field (can be also suppressed). During that period, the OLED will light at a maximal luminescence.
Finally, the GND level is growing to high level (triangular slope field). During this growth, the emitted light from the OLED will go down mirror-invertedly.

Several growing forms for GND can be imagined.

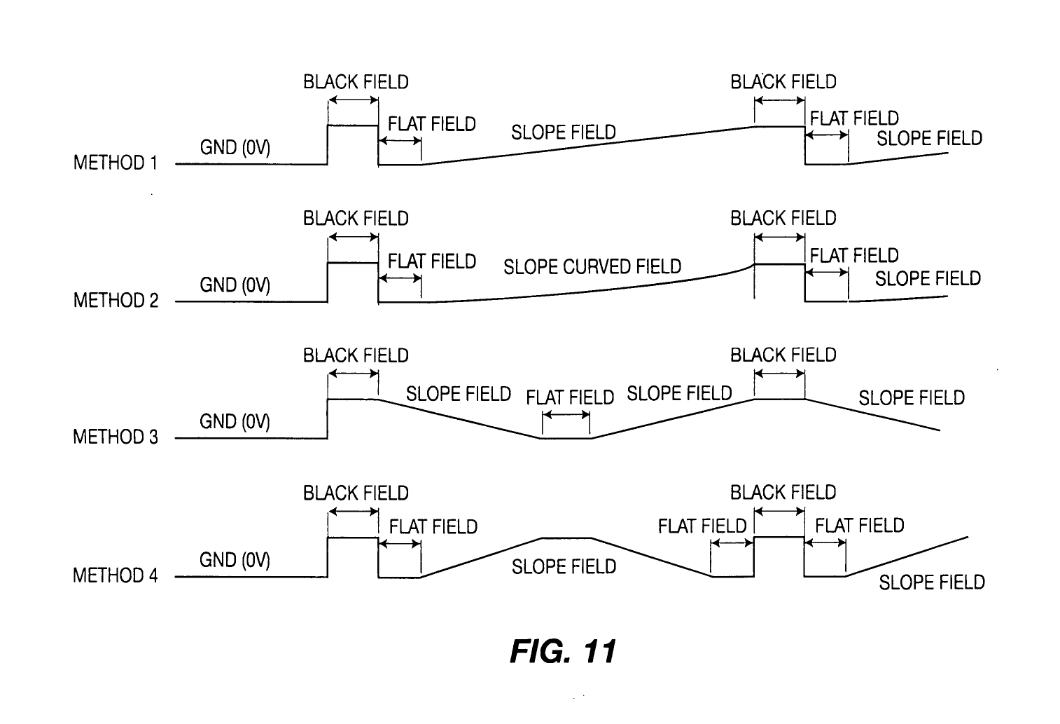

At least four methods for triangle driving (n-channel) are given in FIG. 11. The main important stages are:
Black field corresponding to the whole addressing duration of the screen. During this period of time no light must be emitted. For that purpose it is also possible to use other methods.
Slope fields: here the main important point is that the lighting emission must decay in a similar way as a CRT. In fact, the maximum light emission should only appear on a part of the frame. This is for example not the case for method 4. For this method there is a peak of light at the beginning of the frame and another peak of light at the end. Such a method is not favorable for motion rendition because the two peaks of light within one frame will generate judder.

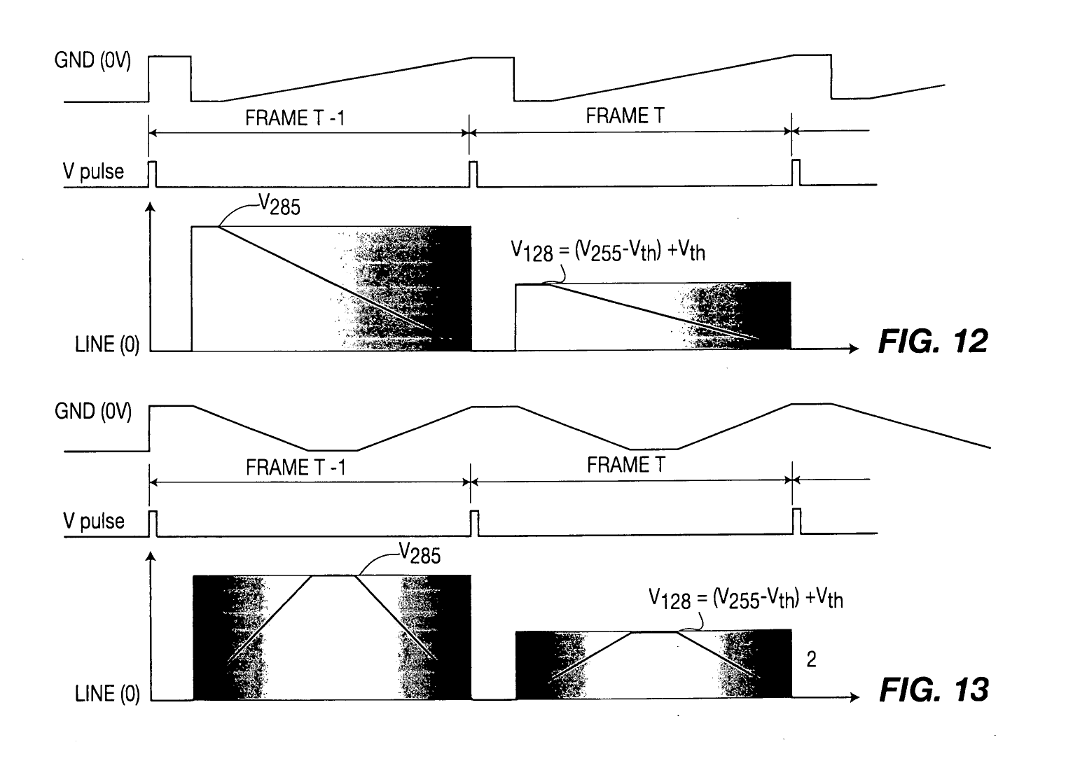

FIG. 12 illustrates the real behavior for method 1 of FIG. 11 for the example given in FIG. 10. The maximum video level of frame T-1 is 255. At the beginning of the frame i.e. after the flat field the brightness of the cell is linearly reduced to zero as the ground potential is increased. According to the present example, the video level of frame T for the given cell is 128, i.e. in the present case of the video level of frame T-1. Again, the brightness of the cell is reduced during frame T until zero as the ground potential GND increases. If the slope field would be characterized by a curve like in method 2 of FIG. 11, the brightness of a cell during the frame would go down degressively.

Furthermore, FIG. 13 shows the brightness behavior of a cell for method 3 of FIG. 11. Similar to FIG. 12 the brightness of the cell is mirror-inverted to the ground potential GND. Here, the brightness curve has the shape of a pyramid.

Both FIGS. 12 and 13 show the basic idea behind the concept: reducing the lighting time over the frame while trying to emulate a CRT like behavior.

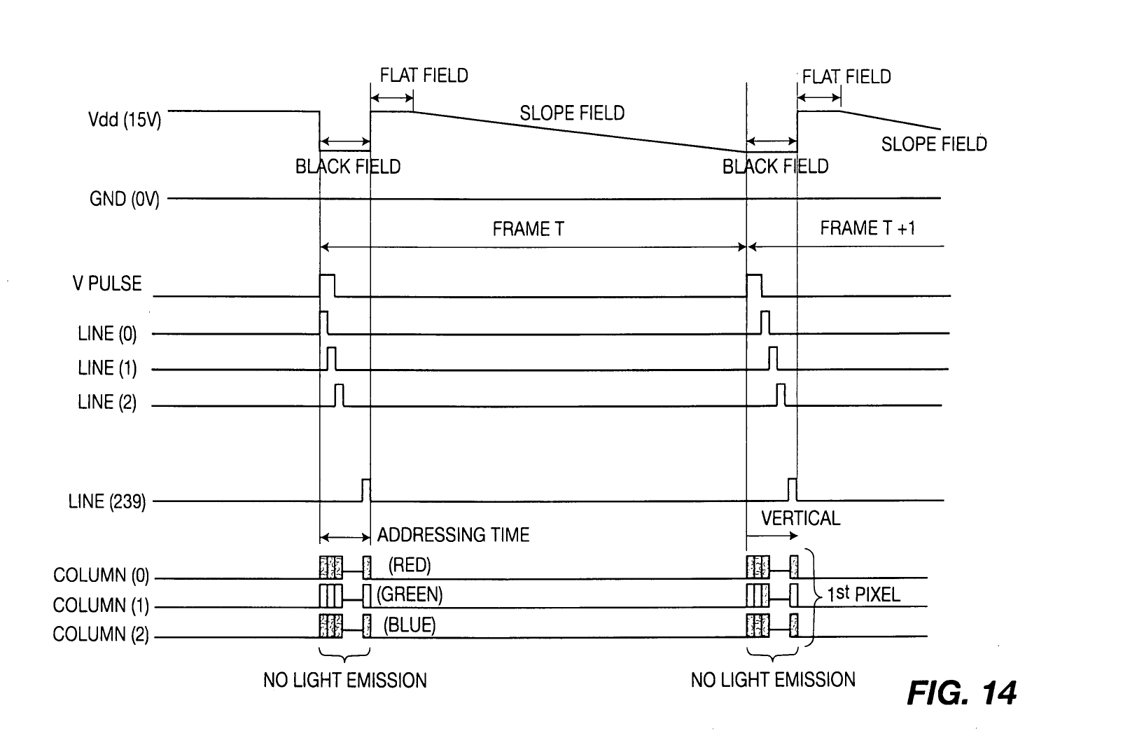

The basic principle for a p-channel TFT is similar to that presented along with FIGS. 10 to 13 except for the fact that now, GND will no more be modified but Vdd. FIG. 14 shows the principle applied to the p-channel transistor. The black fields are achieved by setting Vdd below Vₜₕ. The flat fields are achieved by maintaining Vdd at the maximum value. The only difference is that the changes of Vdd reflect directly the changes of luminance whereas in n-channel type, it is mirror-inverted. The ground potential GND is kept constant. The line and column driving signals are identical to those of the example of FIG. 10.

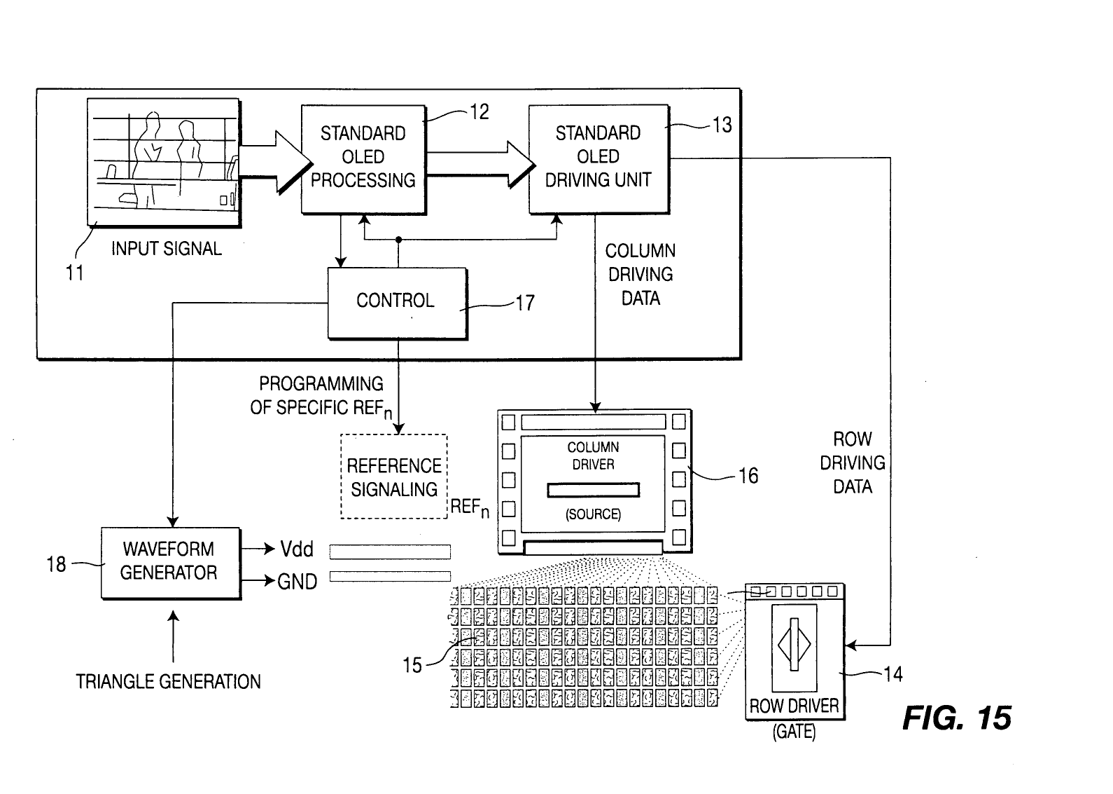

FIG. 15 illustrates an implementation of the inventive solution. The input signal 11 is forwarded to the standard OLED processing unit 12 and driving block 13 as usual. The standard OLED unit 13 produces row driving data for a row driver 14 of an AMOLED 15. Simultaneously, the standard OLED driving unit 13 outputs column driving data to a column driver 16 of the AMOLED 15.

A control unit 17 receives timing information from the input via the standard OLED processing unit 12. With this timing information, the control unit 17 controls a standard OLED processing block 12 and the standard OLED driving unit 13. Furthermore, the control unit 17 controls a reference signal unit 18 by programming specific reference voltages or reference currents input to the column driver 16.

Additionally, the inventive display device shown in FIG. 15 includes a waveform generator 18 for controlling the ground potential GND and/or the driving potential Vdd. The waveform generator 18 itself is controlled and synchronized by the control block 17 to suit with a addressing operation. Specially, the waveform generator is adapted to vary GND and/or Vdd within the time period of a frame or sub-frame. The control block 17 together with the waveform generator 18 are now responsible for the whole inventive driving concept.

1. Method for driving a cell of an AMOLED including the steps of
applying a driving voltage to said cell and
applying a luminance control signal to said cell during a pregiven time frame, and
varying said driving voltage within said time frame according to a predefined triangle function of time.

2. Method according to claim 1, wherein said driving voltage is reduced during a pregiven addressing time period within said time frame.

3. Method according to claim 1, wherein said driving voltage is increased or decreased continuously within said time frame.

4. Method according to claim 1, wherein said driving voltage is increased and decreased continuously in said time frame.

5. Method according to claim 1, wherein said driving voltage is given by a driving potential and a ground potential, and the ground potential or driving potential is modified for varying said driving voltage.

6. Apparatus for driving a cell of an AMOLED including
driving means for applying a driving voltage and a luminance control signal to said cell during a pregiven time frame, and
controlling means for varying said driving voltage within said time frame according to a predefined triangle function of time.

7. Apparatus according to claim 6, wherein said controlling means is capable of reducing said driving voltage during a pregiven addressing time period within said time frame.

8. Apparatus according to claim 6, wherein said controlling means is capable of increasing or decreasing said driving voltage continuously in said time frame.

9. Apparatus according to claim 6, wherein said controlling means is capable increasing and decreasing continuously said driving voltage within said time frame.

10. Apparatus according to claim 6, wherein said driving voltage is given by a driving potential and ground potential, and said controlling means is capable of modifying said ground potential or said driving potential for varying said driving voltage.
